(19) United States
(12) Patent Application Publication
(10) Pub. No.: US 2014/0154441 A1
(43) Pub. Date: Jun. 5, 2014

(54) Reactive Silicon Oxide Precursor Facilitated Anti-Corrosion Treatment

(71) Applicant: Henrik Pranov, Espergaerde (DK)

(72) Inventor: Henrik Pranov, Espergaerde (DK)

(73) Assignee: SiOx ApS, Farum (DK)

(21) Appl. No.: 14/234,952

(22) PCT Filed: Jul. 30, 2012
(86) PCT No.: PCT/DK2012/000087

§ 371 Date: Jan. 24, 2014

(30) Foreign Application Priority Data
Jul. 29, 2011 (DK) PA 2011 00579

(51) Int. Cl. C09D 5/08; C23C 8/36

(52) U.S. Cl. CPC C09D 5/084; C23C 8/36
USPC 428/34.6; 428/336; 427/397.7; 148/241

(57) ABSTRACT

The present invention solves numerous problems in state-of-the-art industrial anti-corrosion protection by using a reactive silicon oxide precursor solution. Among the problems solved are those of decreased heat transfer over a protected surface, limited protection against high-temperature corrosive fluids and difficulties in protecting complex 3D geometries and surfaces with a high surface roughness. The present invention furthermore provides an easy way of making chemical surface functionalization using e.g. silane chemistry. The invention solves these problems by coating the surface of a ceramic or metallic part with a thin layer of a liquid solution of a reactive silicon oxide precursor (rSiO-p) such as Hydrogen Silsesquioxane (HSQ) in Methyl Isobytul Ketone (MIBK) or volatile methyl siloxane (VMS), heating the part to a curing temperature of the rSiO-p, and after a curing time the reactive silicon oxide precursor is transformed into a thin layer of essentially pin-hole free silicon oxide.

### FIELD OF THE INVENTION

The present invention relates to a method and apparatus for making the ceramic or metallic surface corrosion resistant and functionalizable by silane chemistry.

### OBJECT OF THE INVENTION

It may be seen as an object of the present invention to provide an improved method for anti-corrosion treatment ceramic or metallic parts.

It is an object of the present invention to present a technological solution, where the heat transfer capabilities of the surface are less negatively affected than by other methods for anti-corrosion treatment.

It is a further object of the invention to present a technological solution where the anti-corrosion treatment process may be applied to complex 3D geometries without line of sight to the whole or part of the geometry to be anti-corrosion treated.

It is a further object of the invention to present a technological solution where the anti-corrosion treatment process also conveniently provides an adhesion layer for subsequent functionalization using silane chemistry.

It is a further object of the invention to present a technological solution where the surface roughness of the anti-corrosion treated parts are reduced, and where rough surfaces may be anti-corrosion treated.

It is a further object of the present invention to provide an alternative to the prior art.

### SUMMARY OF THE INVENTION

The present invention solves numerous problems in state-of-the-art industrial anti-corrosion protection. The problems solved are those of decreased heat transfer over a protected surface, limited protection against high-temperature corrosive fluids and difficulties in protecting complex 3D geometries.

The present invention furthermore provides an easy way of making chemical surface functionalization using e.g. silane chemistry.

The invention solves these problems by coating the surface of a ceramic or metallic part with a thin layer of a solution of a reactive silicon oxide precursor (rSiO-p) such as Hydrogen Silsesquioxane (HSQ) in Methyl Isobytul Ketone (MIBK) or volatile methyl siloxanes (VMS), heating the part to a curing temperature of the rSiO-p, and after a curing time the part is anti-corrosion treated by a thin layer of silicon oxide. A flow chart of the process is shown in FIG. 1. A schematic figure of the process is shown in FIG. 2.

The invention here presented regards the anti-corrosion treatment of a part consisting of a ceramic or metallic material, comprising a treatment surface to be anti-corrosion treated. First the treatment surface of the part is surface activated, forming reactive surface sites on the treatment surface of the part. Subsequently, the said treatment surface of the part is at least partly coated with a thin film of a solution of a reactive silicon oxide precursor (rSiO-p), preferably a solution of a silsesquioxane, more preferably a solution of Hydrogen Silsesquioxane (HSQ), forming a coated part. The treatment surface of the part may in example comprise channels or reaction chambers in complex 3D geometries where traditional line-of-sight coating methods such as magnetron sputtering or spray coating may not be used. The part is heated to an elevated temperature where the rSiO-p cross-links and forms a thin film of silicon oxide containing material and furthermore forms covalent bonds to the reactive groups of the individual parts of the assembly, thus covalently bonding the individual parts together. For example, HSQ forms a thin layer of silicon dioxide or fused silica, which is very temperature resistant and corrosion resistant at high temperatures. It is furthermore a good adhesion layer for silane chemistry.

Normal use of rSiO-p's such as HSQ is for making electrical insulating layers in semiconductor fabrication. It is furthermore used as a negative electron or deep UV-resist. In general silicon oxide is not being used as a protection layer due to its brittleness, lack of mechanical strength and chemical inertness (which normally causes poor adhesion to the parts to be protected. However, using the disclosed method, a high mechanical strength and good adhesion is achieved.

The novelty and inventive step of using a thin film of rSiO-p for anti-corrosion treatment of metallic or ceramic parts is realized by the surprisingly high corrosion protection of the proposed method due to the absence of pin-holes in the film, the good adhesion strength of the silicon oxide film to the part due to the covalent bonding to the activated surfaces of the individual parts and the thin rSiO-p layer thickness, the ability to coat non-smooth surfaces, with a high surface roughness, which are not suitable for vacuum deposition techniques, and the furthermore high resistance to thermal cycling, which is surprising as the cured silicon oxide has a very low thermal expansion coefficient (e.g. fused silica has a coefficient of 0.59*10⁻⁶/° C.) compared to that of a metal (e.g. Aluminum has a coefficient of 23*10⁻⁶/° C.), which would normally result in delamination of the cured silicon oxide phase relative to the metal phase (the initial part). We have demonstrated that no delamination occurs when cycling anti-corrosion treated aluminum with (cured) HSQ between room temperature and 400° C. 10 times, probably due to the fact that the SiO2 is formed at an elevated temperature, which gives rise to a stress-free state at elevated temperatures, and a state where the SiO2 film is compressed at lower (e.g. room temperature) temperatures. This property is very relevant in high (or low) temperature applications such as heat exchanger or casting mold applications. A further surprising feature is the low change in thermal transfer properties of the treated part, as the layer of silicon oxide is very thin compared by other anti-corrosion treatment methods such as enameling with glass. A further desirable feature is the ability to treat a part without changing the geometry of the part by more than 1-5 μm, which is particularly relevant for micro-channel applications. A further inventive feature of the coating is the chemical and thermal resistance of the cured silicon oxide material after curing. It is resistant to all oxidizing agents except HF, even at temperatures above 1000° C. A further desirable feature is the lowering of the surface roughness due to the coating method, reducing drag resistance in the channels, and the ease of postfunctionalization using silane chemistry, where SiO2 exhibits a far higher density when forming self assembled monolayers of e.g. (1H,1H,2H,2H)-Perfluorodecyltrichlorosilane (FDTS).

### DETAILED DESCRIPTION OF THE INVENTION

Metallic and ceramic parts are used in many devices for different applications, i.e.

molds used for polymer shaping processes, heat exchangers, automobiles, airplanes or other vehicles, home appliances, technical machinery, pumps, electronics, tools, cell culture containers or devices used for diagnostic or chemical processing purposes. In many of these applications the corrosion resistance of the parts may pose limitations to the use of the final device due to corrosion as a result of the fluids getting in contact with the parts during use. The typical solution is to choose corrosion resistant materials, however these are often expensive and have other non-optimal properties, e.g. low thermal conductivity, high weight or poor shaping properties. Therefore much research and effort is put into developing new anti-corrosion treatments with better thermal stability, higher adhesion strength, less pin-holes and better chemical corrosion resistance and longer lifetime, which are all properties whose improvement are desirable. What we here disclose is the surprisingly advantageous use in corrosion treatment applications of a material normally used for a very different purpose, namely electrical isolation of integrated circuits.

Silicon oxide precursors such as hydrogen or methyl silsesquioxane (HSQ or MSQ) are used in semiconductor fabrication as an electrically isolating layer and used in research applications as a negative electron beam or deep UV resist. What we have discovered here is that the chemical inertness, low film thickness, low pin-hole concentration and high adhesion strength to various metallic or ceramic substrates makes this material ideal for anti-corrosion treatment applications due to three surprising issues; the low thickness of the layer makes the silicon oxide tough compared to silicon oxide in a bulk phase (such as quartz or fused silica glass), the low thickness ensures minimal change of thermal transfer properties of the treated part, the silicon oxide precursor is chemically reactive to various substrates, thus making stable, covalent bonds, thereby ensuring a superior adhesion strength, and the low thickness of the film also counteracts the problem of delamination caused by different thermal expansion of the substrate and the bonding layer, even though the thermal expansion coefficient of silicon oxide is very low, and that of e.g. a metallic substrate is very high. The proposed process is essentially a wet coating process, where the adhered reactive silicon oxide precursor is cured to form an inert layer of silicon oxide.

Each step will now be described in detail.

A part consisting of a metallic or ceramic material to be at least partly anti-corrosion treated is brought in contact with a solution of a reactive silicon oxide precursor (rSiO-p) solution, e.g. dip coating or by filling the relevant structure with the solution (in the case of channels or reaction chambers). After contact the majority of the solution is removed or poured of the channels or reaction chambers, eventually through the use of e.g. compressed air. Thereby the treatment surface of the part is coated with a thin layer (<5 μm) of rSiO-p. At least part of the remaining solvent of the solution is allowed to evaporate until the rSiO-p is no longer liquid. This evaporation may be performed in a vacuum chamber or by heating the part to an elevated temperature below the reaction temperature of the rSiO-p. It is important that the whole surface of the treatment surface is brought in contact with the rSiO-p solution to ensure a full coating of the surface. This may be done using vacuum priming of the channels or continuous pumping to get rid of air bubbles in the channels. When this is ensured the part is heated above the reaction temperature of the rSiO-p, thus ensuring covalent cross-linking of the rSiO-p itself as well as covalent bonding to the said part. The heating will typically take place in an oven. After heating the part is cooled to the desired operational temperature, and the part is ready for use. The part may then as an optional step be functionalized by the use of silane chemistry or other types of chemistry reacting well to silicon oxide surfaces.

The invention relates to a method for anti-corrosion treatment of a part, said method comprising at least the following steps:
applying a liquid solution of a reactive silicon oxide precursor onto at least one part of a treatment surface of a part consisting of a metallic or ceramic material.
allowing at least part of the solvent of the liquid reactive silicon oxide precursor solution to evaporate, thereby forming a non-liquid thin layer with a thickness of less than 10 μm, more preferably less than 5 μm and most preferably less than 2 μm of reactive silicon oxide precursor
heating the part to a temperature above the reaction temperature of the reactive silicon oxide precursor, thereby transforming the said reactive silicon oxide precursor layer into a solid layer of silicon oxide while simultaneously forming covalent bonds between the layer of silicon oxide and the said part, transforming the non-treated part into a treated part.

The invention furthermore relates to a method where the said part is surface activated by a plasma containing oxygen prior to the coating with reactive silicon oxide precursor solution.

The invention furthermore relates to a method where the reactive silicon oxide precursor solution is consisting of a silsesquioxane, or preferably hydrogen silsesquioxane in a solvent of either MIBK or VMS.

The invention furthermore relates to a method where the heating of the part is comprising a step where the part is heated to at least 400° C., preferably at least 350° C. and most preferably at least 300° C.

The invention furthermore relates to a method where the heat transfer coefficient of the part to a fluid in contact with the said part is decreased by less than 1%.

The invention furthermore relates to a method where the adhesion strength between the part and the anti-corrosion coating is at least 25 MPa.

The invention furthermore relates to a method where the surface roughness is reduced by at least 25% and where the initial surface roughness of the part is non-smooth, defined by the surface being characterized by a surface roughness Rz of more than 500 nm, or preferably more than 300 nm, more preferably more than 100 nm, even more preferably more than 50 nm and most preferably more than 20 nm.

The invention furthermore relates to a method where the bonding is stable towards thermal cycling between 0° C. and the reaction temperature for at least 10 times.

The invention furthermore relates to a method where the feature areas comprising the layer of silicon oxide is coated with a silane-coupled chemical substance after the assembly.

The invention furthermore relates to an anti-corrosion treated part, such as but not limited to the whole or a part of one of the following; a mold used for polymer shaping processes, a heat exchanger, an automobile, airplane or another vehicle, a home appliance, a tool, a cell culture container or a device used for diagnostic or chemical processing purposes.

An example of a part may be any structure to be corrosion treated, where said part may consist of a metal such as but not limited to aluminum, steel, brass or copper, or consist of a ceramic material such as but not limited to glass, titanium dioxide, aluminum oxide or zirconium oxide. The geometry of the part may be planar or non planar and may comprise channels or reaction chambers

By surface activation is meant the incorporation of chemically reactive groups such as —OH or other oxygen containing groups in the surface of a part. Some materials as e.g. aluminum form reactive groups spontaneously in oxygen-containing gas, whereas other materials as e.g. stainless steel do not, and requires more reactive chemical substances as such as ionized oxygen atom or molecules, which may be obtained by subjecting the part to an oxygen plasma.

By reactive silicon oxide precursor is meant a liquid or soluble chemical substance that may react with itself or with another component to form a solid material primarily (more than 50% of the mass) of silicon and oxygen, such as SiO or SiO2. In general the stochiometric ratio between silicon and oxygen in the reactive silicon oxide precursor will be between (Si:O) 1:1 and 1:2 (e.g. HSQ has a ratio of Si:O of 1:1.5). The reactive silicon oxide precursor will after curing be denoted silicon oxide.

By silicon oxide is meant a solid material primarily (more than 50% of the mass) of silicon and oxygen, such as SiO or SiO2. In general the stochiometric ratio between silicon and oxygen in the silicon oxide will be between (Si:O) 1:1 and 1:2 (e.g. silicon oxide formed by curing of HSQ in inert atmosphere has a ratio of Si:O of 1:1.5, whereas silicon dioxide formed from HSQ in oxygen atmosphere may have a ratio close to 1:2 (Si:O)).

By coating is meant the application of the reactive silicon oxide precursor onto the surface of the part. This may be done submerging the part in a solution of the rSiO-p or pouring the rSiO-p solution into the desired geometry of the part, removing excess rSiO-p solution and allowing the remaining solvent to evaporate, leaving a thin film of rSiO-p. It may also be done using other coating techniques, such as spray coating where the liquid solution of reactive silicon oxide precursor is sprayed on a surface, forming either a thin, dense film, or forming a thin film of individual particles. In the case of a film of particles, this may be transformed into a dense film by subjecting the part to an atmosphere containing vapor of a suitable solvent, e.g. MIBK or VMS, which will be absorbed by the particles until the particles dissolve and flow together to form a dense liquid film. Subsequently the part is placed in an atmosphere with no or less solvent vapor, whereby the liquid film becomes solid. All three coating methods ensure that no pinholes are formed due to the wetability of the solvent relative to the surface (which in the case of inherent non-wetable surface materials are surface activated as described above to ensure a good wetability) and the step where liquid solution of reactive silicon oxide precursor is allowed to wet the surface. In comparison, vacuum deposition techniques do not inherently allow for this surface energy driven coating, and thus are more vulnerable to the formation of pin-holes. Another vulnerability of vacuum deposition techniques is the difficulty in coating non-smooth surfaces, where the surface roughness gives rise to shadow effect on the surface leading to imperfect coating.

By treatment areas is meant the surface areas of a part which will be coated with rSiO-p and subsequently silicon oxide.

By corrosion is meant the disintegration of an engineered material into its constituent atoms due to chemical reactions with its surroundings. It may e.g. refer to electrochemical oxidation of metals in reaction with an oxidant such as oxygen or the degradation of ceramic surfaces such as the reaction of Al2O3 with HCl in aqueous solution.

By corrosion resistant is meant a surface not being degraded by corrosive agents, such as oxidizing agents, strong acids or strong alkali solutions.

By surface roughness is meant the vertical deviations of a real surface from its desired primary or macroscopic form. Large deviations defines a rough surface, low deviations define a smooth surface. Roughness can be measured through surface metrology measurements. Surface metrology measurements provide information on surface geometry. These measurements allow for understanding of how the surface is influenced by its production history, (e.g., manufacture, wear, fracture) and how it influences its behavior (e.g., adhesion, gloss, friction).

Surface primary form is herein referred as the over-all desired shape of a surface, in contrast with the undesired local or higher-spatial frequency variations in the surface dimensions.

Example on how to measure surface roughness are included in the document from the International Organization for Standardization ISO 25178 which collects all international standards relating to the analysis of 3D areal surface texture.

Roughness measurements can be achieved by contact techniques, e.g. by use of profilometers or atomic force microscope (AFM), or by non-contact techniques, e.g. optical instruments such as interferometers or confocal microscopes. Optical techniques have the advantages of being faster and not invasive, i.e. they do physically touch the surface which cannot be damaged.

Surface roughness values herein referred are intended as to be the values of the maximum peak to valley height of the profile along the surface primary form within a 30 μm by 30 μm sampling area with a minimum resolution of 100 nm (distance between neighboring sampling points). The values of maximum valley depth are defined as the maximum depth of the profile below the mean line along the surface primary form sampling length and the values of the maximum peak height are defined as the maximum height of the profile above the mean line along the surface primary form sampling length.

By adhesion layer is meant a layer between a part and a desired surface coating with chemical and physical characteristics allowing both chemical compatibility with the part and the surface coating. An example is the use of silicon oxide or aluminum oxide as adhesion layer for adhering silanes to stainless steel. The steel itself does not have sufficient reactive —OH groups to bind the silane, and hence a layer of silicon oxide or aluminum oxide is used as an intermediate layer between the steel and the silane coating.

By silane chemistry is meant the covalent coupling of an arbitrary chemical substance to a surface through the use of a silane group. The substance designated by R will in its silanized form be designated by R—Si(x)₃ where x will typically be a chloride or methyl group. The reaction with a surface —OH group will be of the type R—Si(x)₃+Surface-OH->Surface-O—Si(x)₂—R+HX. This process may be performed as a gas-phase process (as done in chemical vapor deposition (CVD) or molecular vapor deposition (MVD)) or as a liquid reaction where the silane-coupled substance is brought into contact with the surface to be coated, where the surface is then spontaneously being coated with a self-assembled monolayer of the desired silane R—Si(x)₃.

By MIBK is meant methyl isobutyl ketone.

By VMS is meant a volatile methyl-siloxane.

By FDTS is meant (1H,1H,2H,2H)-Perfluorodecyltrichlorosilane.

By heating to the reaction temperature is meant the process of transforming the reactive silicon oxide precursor into the corresponding solid silicon oxide. This is typically done heating in an oven to a given temperature causing covalent cross-linking of smaller molecular entities into a mesh or grid structure, forming a solid silicon oxide.

In some embodiments the anticorrosion treatment of a part would be treatment of the cooling or heating channels of a mold used for polymer shaping processes, a heat exchanger or a part thereof, a part of an automobile, airplane or another vehicle, a home appliance, a tool, a cell culture container or a device used for diagnostic or chemical processing purposes.

### BRIEF DESCRIPTION OF THE FIGURES

The method and apparatus according to the invention will now be described in more detail with regard to the accompanying figures. The figures show one way of implementing the present invention and is not to be construed as being limiting to other possible embodiments falling within the scope of the attached claim set.

FIG. 1 shows a flow-chart of a method according to one aspect of the invention. The dotted steps are optional, whereas the full-line marked steps are required. An initial part consisting of metallic or ceramic materials with at least one treatment surface (11) is optionally surface activated (12), is then coated with a layer of liquid solution of a reactive silicon oxide precursor on the at least one treatment surface (13), excess solution is removed and the excess solvent of the remaining liquid reactive silicon oxide precursor is allowed to at least partly evaporate leaving a thin non-liquid film of reactive silicon oxide precursor on the treatment surface (14), which is heated to the reaction temperature forming a treated part (15). Subsequently, the part is optionally surface treated with a silane based chemistry (16), yielding the final treated part (17).

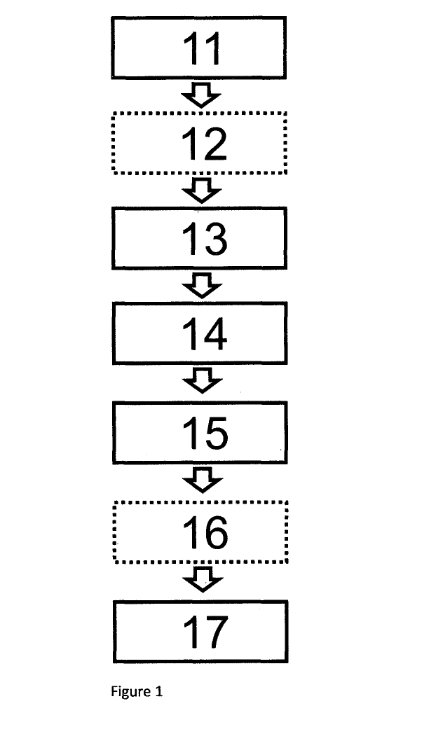

FIG. 2a shows a schematic drawing of a part (1) comprising internal areas to be anti-corrosion treated (2), FIG. 2b shows the filling of the internal structures (2) of the part (1) with a solution of the reactive silicon oxide precursor (3), FIG. 2c shows the part (1) after removing the excess solution, leaving a thin film of reactive silicon oxide precursor (4). FIG. 2d showing the final treated part (1) comprising a thin layer of silicon dioxide (5) on the internal surface (2) after the heating to the reaction temperature.

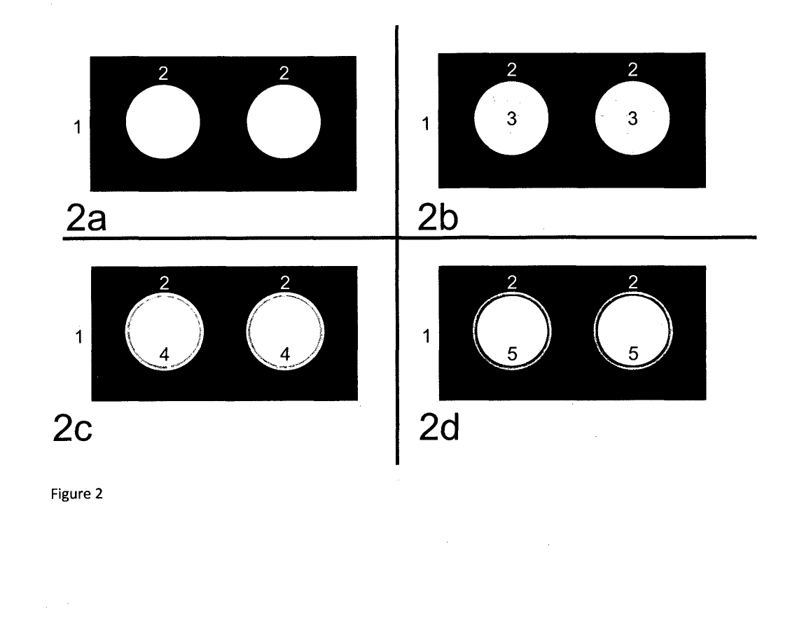

FIG. 3a shows a schematic drawing of a part (1) comprising external areas to be anti-corrosion treated, FIG. 3b shows the coating of the external structures of the part (1) with a solution of the reactive silicon oxide precursor (2) by submersion in a silicon oxide precursor solution bath (3), FIG. 3c shows the part (1) after removing the part from the bath, leaving a thin film of reactive silicon oxide precursor (4). FIG. 3d showing the final treated part (1) comprising a thin layer of silicon dioxide (5) on the external surface after the heating to the reaction temperature.

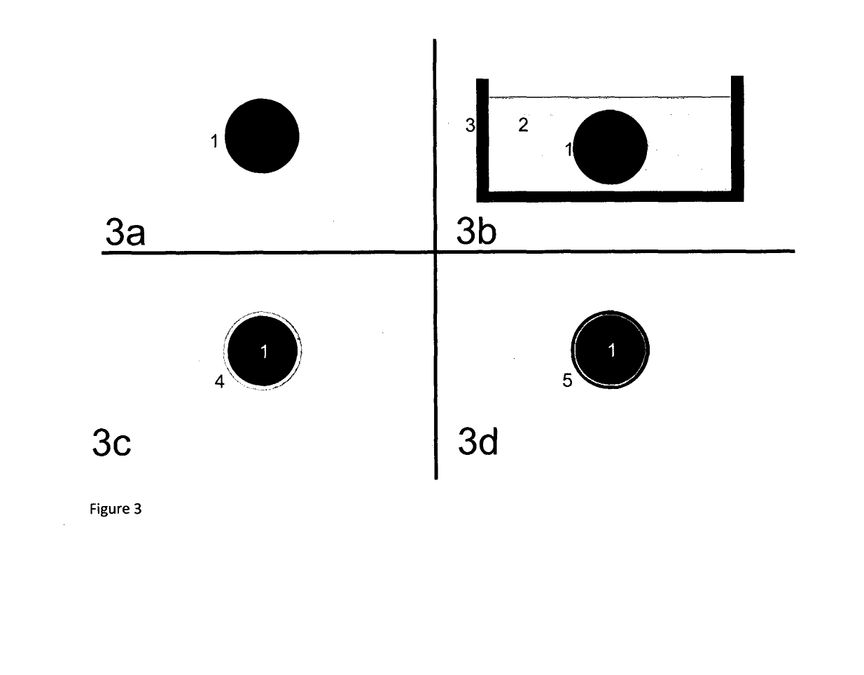

FIG. 4 shows a schematic drawing of a cross-section of an initial surface (1) where the surface roughness (2) has been lowered through the deposition of silicon oxide (3) using the described method to yield a lower final surface roughness (4).

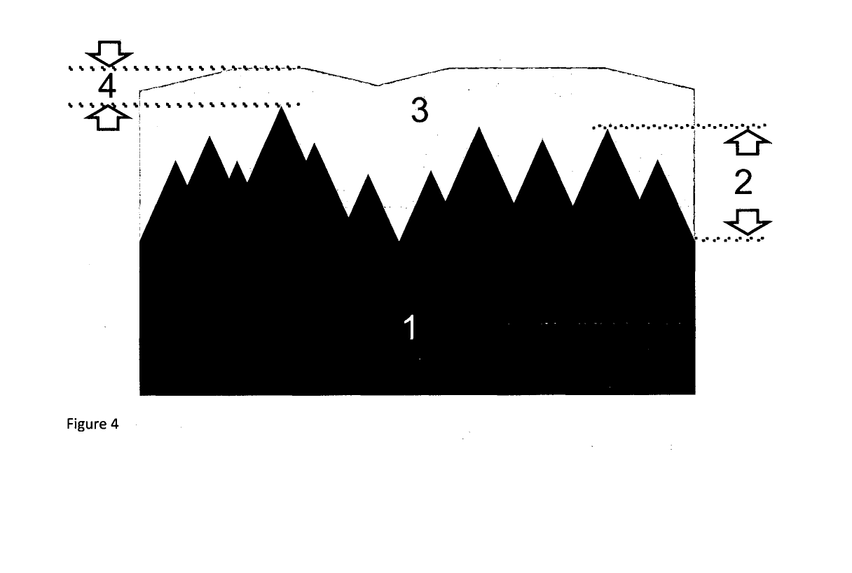

### DETAILED DESCRIPTION OF AN EMBODIMENT

In a first example the internal volume of a steel-plate heat exchanger is flushed with an oxygen plasma for surface activation, subsequently filled with a 5% solution of HSQ in MIBK. The volume of solution is circulated through the internal volume and an air trap to ensure full contact (no bubbles) between the internal volume of the heat exchanger and the solution. After a circulation time of 15 minutes, the solution is pumped out and the internal volume of the heat exchanger is flushed by pressurized air to remove as much solution as possible while simultaneously removing the remnant solvent, leaving a uniform film of HSQ on the internal surface of the heat exchanger. The heat exchanger is heated using hot pressurized air to 400° C., allowing the HSQ to form covalent bonds to the surface activated steel plates and cross-linking to itself, forming a thin film of silicon oxide, acting as an anti-corrosion coating. The heat exchanger is then used for corrosive or reactive chemicals where the heat transfer coefficient is not lowered significantly compared to the untreated heat exchanger.

In a second example an aluminum injection molding mold made by powder laser sintering techniques with a complicated inner 3D geometry comprising cooling channels are filled with a 1% solution of HSQ in MIBK, recirculated 100 times in series with a bubble trap, flushed with compressed air for efficient re-collection of the HSQ solution, heated to 450° C. in an oven, and subsequently cooled to room temperature. The treated mold is subsequently used for injection molding of polymers into polymeric parts.

In a third example a glass microfluidic system is coated surface activated by flushing an oxygen plasma through the channels, which are subsequently filled with a 10% solution of HSQ in VMS. The solution is flushed out, and the microfluidic system is heated to 300° C., leaving a protective layer of silicon oxide, preventing sodium ions from the glass to enter any solution which the glass microfluidic system would interact with.

In a fourth example a low carbon steel turbine wing for a gas-powered generator is plasma treated in a plasma chamber, and subsequently dip-coated in a 20% solution of HSQ in MIBK (Fox-16 from Dow Corning). The turbine wing is then baked in an oven at 600° C. for one hour, leaving a 5 μm thin film of silicon oxide. The turbine is then used in a high temperature generator where it is resistant to steam and oxygen at temperatures of 1000° C.

In a fifth example an aluminum plate of an aluminum heat exchanger must be anti-corrosion treated. The plate is cleaned and surface activated by an oxygen plasma. Subsequently the whole surface of the plate is spray coated with HSQ (Fox-12 from Dow Corning), forming a pin-hole free film. The plate is heated to 400° C. for one hour, thus forming a 500 nm layer of silicon oxide on the plate. This coating protects the aluminum plate from corrosion from chlorine in the process water and does not have any significant influence on the heat transfer capability of the heat exchanger. The treatment makes it possible to use a much smaller and cheaper aluminum heat exchanger instead of a stainless steel heat exchanger, where the cost is mainly associated with the cumbersome shapeability of stainless steel and the (low) efficiency is related to the poor heat conductance properties of stainless steel.

In a sixth example an aluminum part of an airplane wing must be anti-corrosion treated. The wing is cleaned and surface activated by an oxygen plasma. Subsequently the whole surface of the wing is spray coated with HSQ (Fox-12 from Dow Corning). The wing is heated by IR radiation to 400° C. for one hour, thus forming a 500 nm layer of silicon oxide on the airplane wing. To make the wing less susceptible for ice, the wing is surface treated with FDTS in a wet coating process.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

All patents and non-patent references cited in the present application are also hereby incorporated by reference in their entirety.

1.-10. (canceled)

11. A method for anti-corrosion treatment of a part, said method comprising at least the following steps:
applying a liquid solution of a reactive silicon oxide precursor using a coating process onto at least one part of a treatment surface of a part consisting of a metallic or ceramic material.
allowing at least part of the solvent of the liquid reactive silicon oxide precursor solution to evaporate, thereby forming a non-liquid thin layer with a thickness of less than 10 μm of reactive silicon oxide precursor
heating the part to a heating temperature above a reaction temperature of the reactive silicon oxide precursor, thereby transforming the reactive silicon oxide precursor layer into a solid layer of silicon oxide while simultaneously forming covalent bonds between the layer of silicon oxide and the part, transforming the non-treated part into a treated part.

12. A method according to claim 11, wherein the part is surface activated by a plasma containing oxygen prior to the coating with reactive silicon oxide precursor solution.

13. A method according to claim 11, wherein the reactive silicon oxide precursor solution consists of a silsesquioxane in a solvent of either methyl isobutyl ketone (MIBK) or volatile methyl siloxanes (VMS).

14. A method according to claim 13, in which the silsesquioxane is hydrogen silsesquioxane.

15. A method according to claim 11, wherein the heating temperature is at least 300° C.

16. A method according to claim 15, wherein the heating temperature is at least 400° C.

17. A method according to claim 15, wherein the covalent bonds are stable in thermal cycling between 0° C. and the heating temperature for at least 10 cycles.

18. A method according to claim 11, wherein the heat transfer coefficient of the part to a fluid in contact with the part is decreased by less than 1% as a result of treatment of the part.

19. A method according to claim 11, wherein adhesion strength between the part and the solid layer of silicon oxide is at least 25 MPa.

20. A method according to claim 11, in which the thickness of the non-liquid thin layer is less than 2 μm.

21. A method according to claim 11, wherein the treatment surface of the part is non-smooth with a surface roughness Rz of more than 20 nm prior to said applying and a surface roughness of the treated part is at least 25% lower than the surface roughness of the treatment surface prior to said applying.

22. A method according to claim 21, wherein the surface roughness Rz is from 20 to 300 nm.

23. A method according to claim 11, further comprising, after said heating, coating at least the treatment surface of the part comprising the solid layer of silicon oxide with a silane-coupled chemical substance after assembly.

24. An anti-corrosion treated part made by the method of claim 11.

25. An anti-corrosion treated part according to claim 24, wherein the part is the whole or part of a part selected from: a mold used for polymer shaping processes, a heat exchanger, a pump, an automobile, airplane or another vehicle, a home appliance, a tool, a cell culture container, or a device used for diagnostic or chemical processing purposes.
